(19) United States
(12) Patent Application Publication
(10) Pub. No.: US 2015/0072752 A1
(43) Pub. Date: Mar. 12, 2015

(54) ELECTRONIC GAMING SYSTEM WITH UNIVERSAL PLAYER TRACKING

(71) Applicant: Scott Melnick, Decatur, GA (US)

(72) Inventor: Scott Melnick, Decatur, GA (US)

(73) Assignee: CADILLAC JACK, Duluth, GA (US)

(21) Appl. No.: 14/022,388

(22) Filed: Sep. 10, 2013

(51) Int. Cl. G07F 17/32; G07F 17/34

(52) U.S. Cl. CPC G07F 17/3255; G07F 17/323; G07F 17/34
USPC 463/20

(57) ABSTRACT

Examples disclosed herein relate to systems and methods for utilizing one or more universal player tracking systems. The electronic gaming device may include a memory, a processor, and a plurality of reels. The plurality of reels may include one or more areas. The memory may include a universal player tracking module. The processor may generate one or more symbols to be located in the one or more areas and to validate one or more universal player tracking numbers based on data received from an external device.

### FIELD

The subject matter disclosed herein relates to an electronic gaming systems and methods for providing a player tracking system, which is universal to one or more different gaming entities. More specifically, the disclosure relates to systems, devices, and methods, which provide universal player tracking for one or more distinct gaming entities.

### INFORMATION

The gaming industry has numerous casinos located both worldwide and in the United States. A client of a casino or other gaming entity can gamble via various games of chance. For example, craps, roulette, baccarat, blackjack, and electronic or electromechanical games (e.g., a slot machine, a video poker machine, and the like) where a person may gamble on an outcome.

Historically, electronic gaming systems comprise a significant portion of a casino offering, and are therefore very important to the industry. Typically, a player must have more than one player tracking card to obtain player points (e.g., rewards for game play) at more than one distinct gaming entity. The need for more than one player tracking card is inconvenient to the player and limits the player's ability to increase their player's point's balance when visiting more than one distinct gaming entity. More rewards and greater prizes may be obtained by the player if one or more gaming entities employ a player tracking card that works in a few, a plurality, and/or all of the gaming entities where the player makes one or more wagers.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5 is a diagram of an exemplary gaming device, according to one embodiment.

FIG. 6 is a diagram of an exemplary mobile device, according to one embodiment.

FIG. 7 is a diagram of an exemplary gaming device, according to one embodiment.

FIG. 8 is an illustration of an exemplary universal player tracking program, according to one embodiment.

FIG. 9 is a flow diagram for the universal registration procedure, according to one embodiment.

FIG. 10 is a flow diagram for a verification procedure, according to one embodiment.

FIG. 11 is a flow diagram for modifying a player's balance, according to one embodiment.

FIG. 12 is another flow diagram for modifying a player's balance, according to one embodiment.

FIG. 13 is a flow diagram for storing player information, according to one embodiment.

FIG. 14 is a flow diagram for game play, according to one embodiment.

FIG. 15 is another flow diagram for game play, according to one embodiment.

FIG. 16 is another flow diagram for a registration procedure, according to one embodiment.

### DETAILED DESCRIPTION

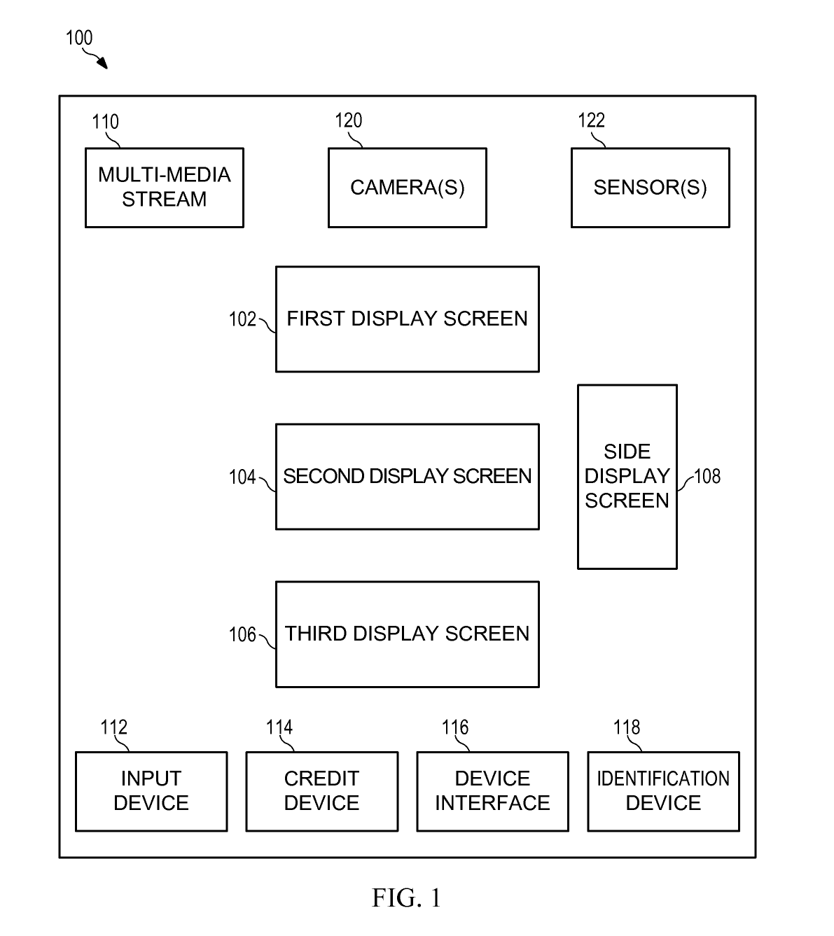

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, an identification device 118, one or more cameras 120, and/or one or more sensors 122. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to make a wager, to obtain player's point balances, to obtain universal player's point balances, to obtain any player point data, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, a player may prefer to utilize gaming options, which support their universal player's card. In one example, a first gaming machine may provide points for an individual utilizing their universal player's card. Whereas, a second gaming machine only provides points for a casino specific player's card. In a further example, a third gaming machine may have a first game type, which provides points for the universal player's card and a second game type, which does not provide points for the universal player's card (e.g., only provides points (e.g., rewards) for a casino specific player's card). In various examples, the gaming machine may reconfigure itself to support universal players' cards. This reconfiguration may include modifying the payout ratio, changing the game type, modifying the game type, and/or modifying any other gaming characteristics. For example, the casino may have a first payout ratio for a player that utilizes a casino specific player's card and a second payout ratio when a player utilizes the universal player's card. In one example, the first payout ratio is higher than the second payout ratio to encourage a player to utilize the casino specific player's card. In another example, the second payout ratio is higher than the first payout ratio to encourage a player to utilize the universal player's card. In another example, the second payout ratio is lower than the first payout ratio to recover the additional expenses (e.g., cashing in points not earn at this casino, etc.) associated with the usage of the universal player's card. In one example, the payout ratio may be the rate that the player points may be earned (e.g., 100 points for every $5 average bet over an hour, 250 points for every $10 average bet over ½ an hour, etc.). In another example, the payout ratio may be the winning percentage target (e.g., 96% payback, 90% payback, etc.) on the gaming machine. For example, a 90% payback would mean that for every $1 bet that the average returned to the player over some time period would be $0.9. In another example, the language, sound level, music, placement of multi-media streams, one or more game functionalities (e.g., game type 1, game type 2, game type 3, etc.) may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include pattern gaming options only. Therefore, only games which include pattern gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display that the electronic gaming machine supports universal player cards, to display one or more warnings relating to game security, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

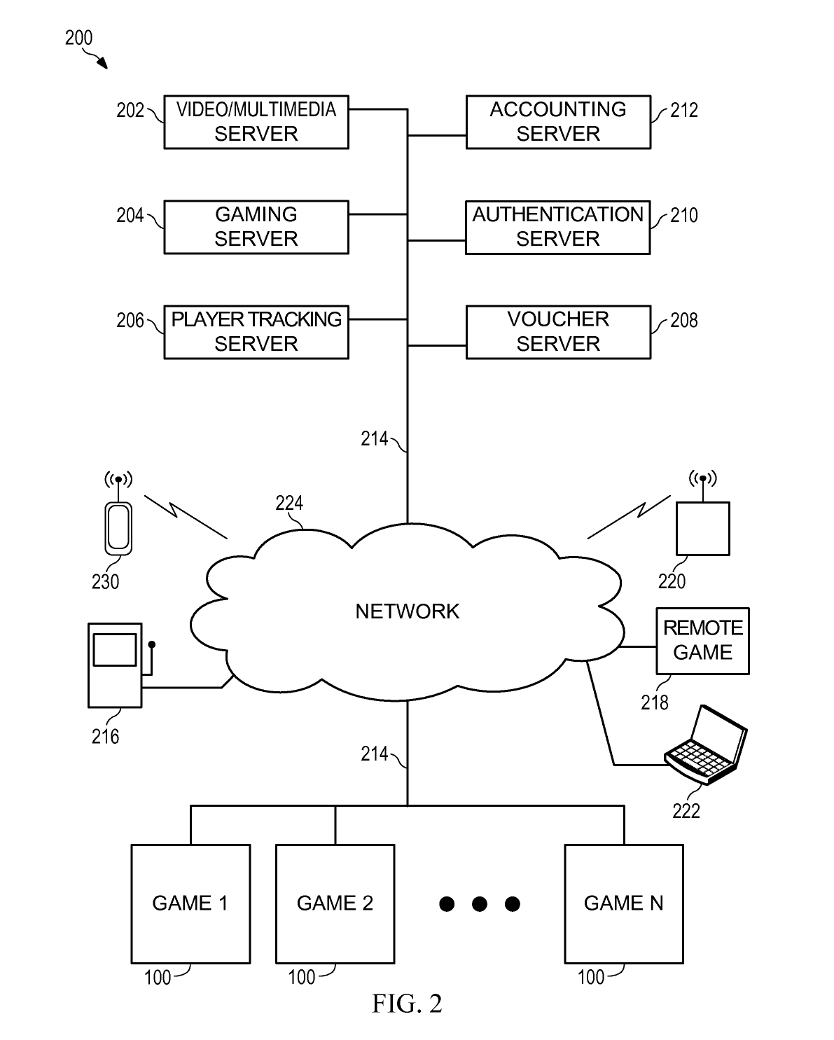

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of a payout functionality, a game play functionality, a game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.). Player tracking server 206 may be utilized for both the universal player tracking card system and/or one or more casino specific player tracking card systems. Player tracking server 206 may be utilized to provide debits and credits to one or more gaming entities. For example, a first player earns 30,000 points at a first casino and earns another 1,000 points at a second casino. The first player then decides to utilize the 31,000 points at the second casino to purchase a watch (e.g., retail value equals $3,100−actual cost to the second casino=$1,000). In one example, the first casino may owe the second casino the cost of the 30,000 points (e.g., $3,000). In another example, the first casino may owe the second casino a percentage of the actual cost. For example, $1,000×30,000/31,000=$967.75. These debits and credits may be offset and paid out during a specific time period (e.g., monthly, quarterly, annually, etc.). Further, these transactions may be audited by a third party and/or any party. In another example, no payments from a first casino to a second casino may be made. In this example, each casino would be responsible for their own cost. In another example, the rate of points earned may be different at various casinos (e.g., for a $5 bet on average for an hour a player earns 100 points at a first casino but earns 200 points at a second casino). In another example, the points may be worth the same value at all casinos (e.g., $0.01 per point). In another example, the points may be worth different values at different casinos (e.g., $0.01 per point at a first casino, $0.02 per point at a second casino, $0.25 per point at an Nth casino).

Voucher server 208 may generate a voucher, which may include data relating to gaming. Further, the voucher may include payline structure option selections. In addition, the voucher may include player point data (e.g., balances, etc.), game play data (or similar game play data), repeat payline data, pattern data, historical payout data, column data, row data, and/or symbols that were modified.

Authentication server 210 may determine the validity of player cards, universal player cards, vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes. Accounting server 212 may generate one or more expense reports for the universal player tracking system and/or any other report (e.g., player's point balances, player point rankings, frequency of use, etc.).

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

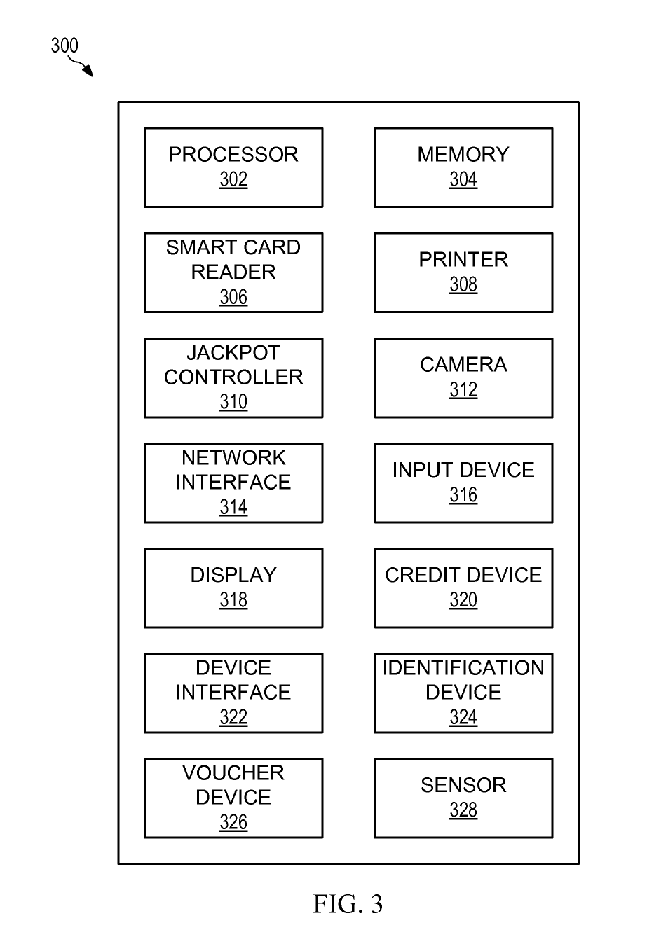

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device. For example, a player may prefer to utilize gaming options, which support their universal player's card. In one example, a first gaming machine may provide points for an individual utilizing their universal player's card. Whereas, a second gaming machine only provides points for a casino specific player's card. In a further example, a third gaming machine may have a first game type, which provides points for the universal player's card and a second game type, which does not provide points for the universal player's card (e.g., only provides points (e.g., rewards) for a casino specific player's card). In various examples, the gaming machine may reconfigure itself to support universal players' cards. This reconfiguration may include modifying the payout ratio, changing the game type, modifying the game type, and/or modifying any other gaming characteristics. For example, the casino may have a first payout ratio for a player that utilizes a casino specific player's card and a second payout ratio when a player utilizes the universal player's card. In one example, the first payout ratio is higher than the second payout ratio to encourage a player to utilize the casino specific player's card. In another example, the second payout ratio is higher than the first payout ratio to encourage a player to utilize the universal player's card. In another example, the second payout ratio is lower than the first payout ratio to recover the additional expenses (e.g., cashing in points not earn at this casino, etc.) associated with the usage of the universal player's card. In one example, the payout ratio may be the rate that the player points may be earned (e.g., 100 points for every $5 average bet over an hour, 250 points for every $10 average bet over ½ an hour, etc.). In another example, the payout ratio may be the winning percentage target (e.g., 96% payback, 90% payback, etc.) on the gaming machine. For example, a 90% payback would mean that for every $1 bet that the average returned to the player over some time period would be $0.9.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. In one example, this image may be utilized to verify that the player's identity matches to the universal player's tracking card being utilized (e.g., photo on file is compared to image to ensure that the correct person is using the universal player's tracking card). For example, when a player sits down at the machine their picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money, player points, and/or credits. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.). This information may include QR codes, other codes, and/or any other player data.

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data. For example, a player may prefer to utilize gaming options, which support their universal player's card. In one example, a first gaming machine may provide points for an individual utilizing their universal player's card. Whereas, a second gaming machine only provides points for a casino specific player's card. In a further example, a third gaming machine may have a first game type, which provides points for the universal player's card and a second game type, which does not provide points for the universal player's card (e.g., only provides points (e.g., rewards) for a casino specific player's card). In various examples, the gaming machine may reconfigure itself to support universal players' cards. This reconfiguration may include modifying the payout ratio, changing the game type, modifying the game type, and/or modifying any other gaming characteristics. For example, the casino may have a first payout ratio for a player that utilizes a casino specific player's card and a second payout ratio when a player utilizes the universal player's card. In one example, the first payout ratio is higher than the second payout ratio to encourage a player to utilize the casino specific player's card. In another example, the second payout ratio is higher than the first payout ratio to encourage a player to utilize the universal player's card. In another example, the second payout ratio is lower than the first payout ratio to recover the additional expenses (e.g., cashing in points not earn at this casino, etc.) associated with the usage of the universal player's card. In one example, the payout ratio may be the rate that the player points may be earned (e.g., 100 points for every $5 average bet over an hour, 250 points for every $10 average bet over ½ an hour, etc.). In another example, the payout ratio may be the winning percentage target (e.g., 96% payback, 90% payback, etc.) on the gaming machine. For example, a 90% payback would mean that for every $1 bet that the average returned to the player over some time period would be $0.9.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, player point data, universal player point data, and/or any other wagering data. A voucher may represent an award, which may be used at other locations inside of the gaming establishment. For example, the voucher may be a coupon for the local buffet or a concert ticket.

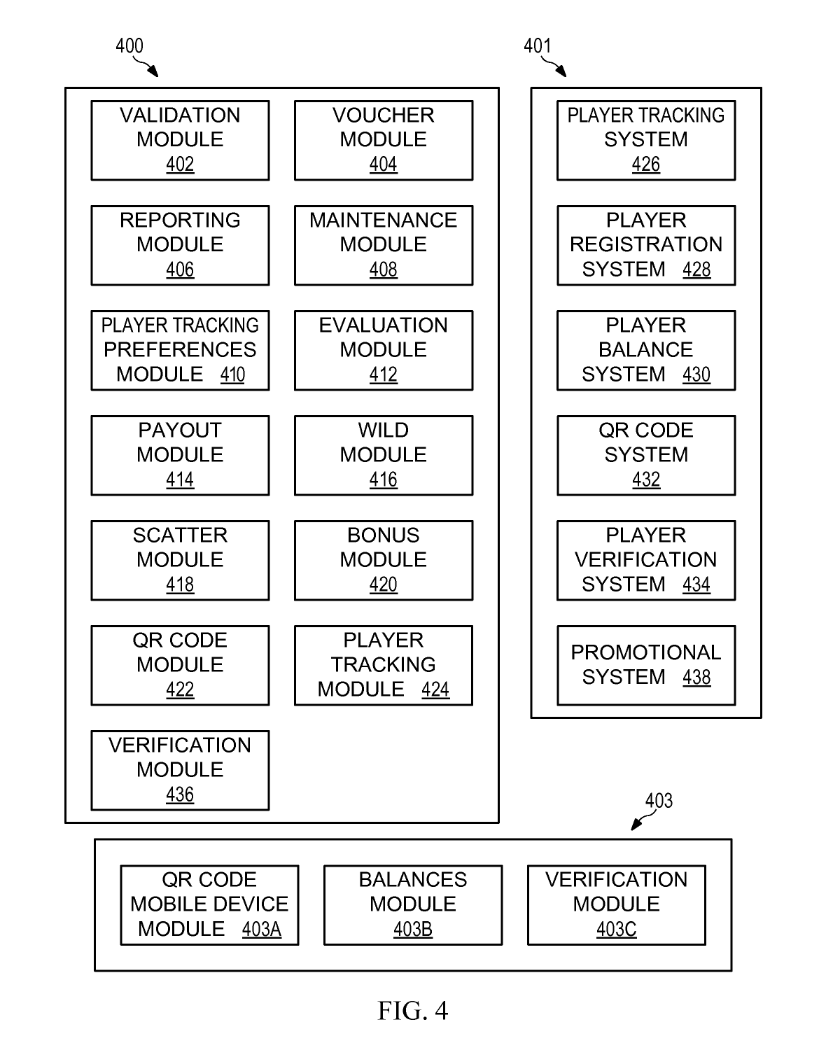

FIG. 4 shows a block diagram of memory 304, which includes various modules. Memory 304 may include a validation module 402, a voucher module 404, a reporting module 406, a maintenance module 408, a player tracking preferences module 410, an evaluation module 412, a payout module 414, a wild module 416, a scatter module 418, a bonus module 420, a QR module 422, a player tracking module 424, and a verification module 436. Further memory 304 may interact with one or more systems 401 and/or one or more mobile devices 403. One or more systems 401 may include a player tracking system 426, a player registration system 428, a player balance system 430, a QR code system 432, a player verification system 434, and a promotional system 438. One or more mobile devices 403 may include QR code mobile device module 403A, a balances module 403B, and a mobile device verification module 403C.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Evaluation module 412 may evaluate one or more outcomes for one or more events relating to game play.

Payout module 414 may determine one or more payouts which may relate to one or more inputs received from the player, electronic gaming device 100, and/or electronic gaming system 200.

Wild module 416 may generate a wild game, evaluate the results of the wild game, trigger wild game presentations, generate wild game payouts, and/or display any data relating to the wild game. Further, wild module 420 may determine one or more outcomes of one or more interactions (e.g., collisions of one or more symbols).

Scatter module 418 may generate a scatter game, evaluate the results of the scatter game, trigger scatter game presentations, generate scatter game payouts, and/or display any data relating to the scatter game.

Bonus module 420 may generate a bonus game, evaluate the results of the bonus game, trigger bonus game presentations, generate bonus game payouts, and/or display any data relating to the bonus game.

QR module 422 may compile, generate, obtain, receive, and/or transmit one or more QR codes from one or more computing devices (e.g., mobile devices, servers, etc.). These QR codes may be utilized (e.g., via a smartphone, server, etc.) to obtain and verify the universal player's card information. Further, one or more QR codes may be generated and utilized to obtain tournament information, cash in prizes, sign-up for additional tournaments, schedule another tournament, book a hotel room, receive one or more advertisements and/or offers, obtain a credit line, book a restaurant reservation, and/or obtain any other service. In addition, any other codes may be utilized in combination with the QR codes and/or as a standalone option. For example, bar codes may be utilized by the player via one or more devices to obtain more tournament information, cash in their prize, sign-up for additional tournaments, schedule another tournament, book a hotel room, receive one or more advertisements and/or offers, obtain a credit line, book a restaurant reservation, and/or obtain any other service. The QR code may be unique and encrypted for each individual user. In one example, using QR codes for player tracking, player rewards/bonus, lotteries, and TITO (“ticket in-ticket out”) may allow for a player to have only 1 personalized and unique QR code assigned to them that is usable at any casino, player tracking system, and/or online gaming site. In one example, a player may register with a special system (e.g., player tracking system, etc.) to obtain their own personal QR code (e.g., version 10, version 40, etc.). The QR code may be stored on a smart phone and/or any other device that can hold a picture or print out a QR code. In one example, upon arrival at a casino and/or at an online gaming site, the player could register their personal QR code with that casino's system and/or specialized tracking system, which allows the player to have only 1 tracking number for all systems. Further, slot machines and/or other gaming devices may contain a camera to scan the QR codes and register the player with the game. Online gaming site can use a user's camera and/or upload a JPEG of the QR code image. In another example, an additional method for using the QR code would be for TITO. Where instead of inserting a ticket, the personal QR code would be scanned into the device to transfer the player's funds and/or to manage the player's funds (e.g., debits, credits, transfers, etc.). The QR code is registered with the casino backend system and funds are associated with the QR code are transparent. Further, security information can be encrypted and added to the QR code, such as, a personal pin number that may be required to cash in the funds on the QR code and/or any other action necessary that requires a security transaction. In addition, photo data, biometric data, partial key information for finger prints, and/or any other security data may be stored on the QR codes.

In various examples, QR codes were utilized on a mobile device to implement the universal player card tracking system. However, this disclosure is not limited to the type of media utilized and/or any type of coding. For example, a piece of paper (e.g., with some coding, etc.) which provides a unique code for a player may be utilized and inputted into the electronic universal player card tracking system. Further, a plastic card (e.g., player card, credit card, etc.) which provides a unique code for a player may be utilized and inputted into the electronic universal player card tracking system. Further, any other electronic device (and/or non-electronic device (e.g., paper, etc.)) may be inputted into one or more of a ticket scanner, a card scanner, an IR device, a camera, etc.). Further, any format for the coding (e.g., QR, Serial, encrypted string) may be utilized. The coding may be unique to an individual and may not be duplicated. All of the examples for QR coding in this disclosure may be utilized with any of the items (e.g., paper, plastic card, ticket scanner, card scanner, an IR device, camera, serial code, encrypted string, etc.) by replacing the QR coding and/or working in combination with the QR coding. In addition, biometric data (e.g., finger print, face recognition data, etc.) may be utilized to identify the player in combination with any of the above devices and/or as a sole identification source.

Player tracking module 424 may track a player's betting activity on this specific electronic gaming machine. This information may be generated, compiled, and transmitted to one or more servers. Based on data generated by player tracking module 424, a player may be eligible for gaming rewards (e.g., free play), promotions, and/or other awards (e.g., complimentary food, drinks, lodging, concerts, etc.). Player tracking module 424 may be utilized for both the universal player tracking card system and one or more casino specific player tracking card systems. Player tracking module 424 via player tracking server 206 may be utilized to provide debits and credits to one or more gaming entities. For example, a first player earns 30,000 points at a first casino and earns another 1,000 points at a second casino. The first player then decides to utilize the 31,000 points at second casino to purchase a watch (e.g., retail value equals $3,100−actual cost to second casino=$1,000). In one example, the first casino may owe the second casino the cost of the 30,000 points (e.g., $3,000). In another example, the first casino may owe the second casino a percentage of the actual cost. For example, $1,000×30,000/31,000=$967.75. These debits and credits may be offset and paid out during a specific time period (e.g., monthly, quarterly, annually, etc.). Further, these transactions may be audited by a third party and/or any party.

Verification module 436 may generate, store, and transmit one or more universal player tracking card verification signals (e.g., data). For example, verification module 436 may communicate with player verification system 434 located at a remote server and/or mobile device verification module 403C located on a mobile device to confirm/verify the codes associated with the player's universal tracking card.

Player tracking system 426 may track a player's betting activity, a player's preferences (e.g., language, font, sound level, drinks, etc.). Based on data obtained by player tracking system 426, a player may be eligible for gaming rewards (e.g., free play), promotions, and/or other awards (e.g., complimentary food, drinks, lodging, concerts, etc.). Player tracking system 426 may be utilized for both the universal player tracking card system and one or more casino specific player tracking card systems. Player tracking system 426 may be utilized to provide debits and credits to one or more gaming entities. For example, a first player earns 30,000 points at a first casino and earns another 1,000 points at a second casino. The first player then decides to utilize the 31,000 points at second casino to purchase a watch (e.g., retail value equals $3,100−actual cost to second casino=$1,000). In one example, the first casino may owe the second casino the cost of the 30,000 points (e.g., $3,000). In another example, the first casino may owe the second casino a percentage of the actual cost. For example, $1,000×30,000/31,000=$967.75. These debits and credits may be offset and paid out during a specific time period (e.g., monthly, quarterly, annually, etc.). Further, these transactions may be audited by a third party and/or any party.

Player registration system 428 may generate, compile, receive, and/or transmit data relating to registering one or more players for the universal player card system. For example, a first player may provide personal data to generate their universal player's card number.

Player balance system 430 may generate, compile, receive, and/or transmit data relating to a player universal player's card's balance. Player balance system 430 may communicate with balances module 403B on mobile device to track, verify, and/or modify a player's universal card balance.

QR code system 432 may generate, compile, receive, and/or transmit data relating to one or more QR codes. QR code system 432 may communicate with QR code mobile device module 403A to track, verify, and/or modify one or more QR codes associated with the player's universal player card.

Promotional system 438 may generate, compile, store, and/or transmit data relating to one or more promotions for one or more universal player tracking card systems.

It should be noted that one or more modules may be combined into one module. Further, there may be one evaluation module where the determined payout does not depend on whether there were any wild symbols, scatter symbols, platform based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

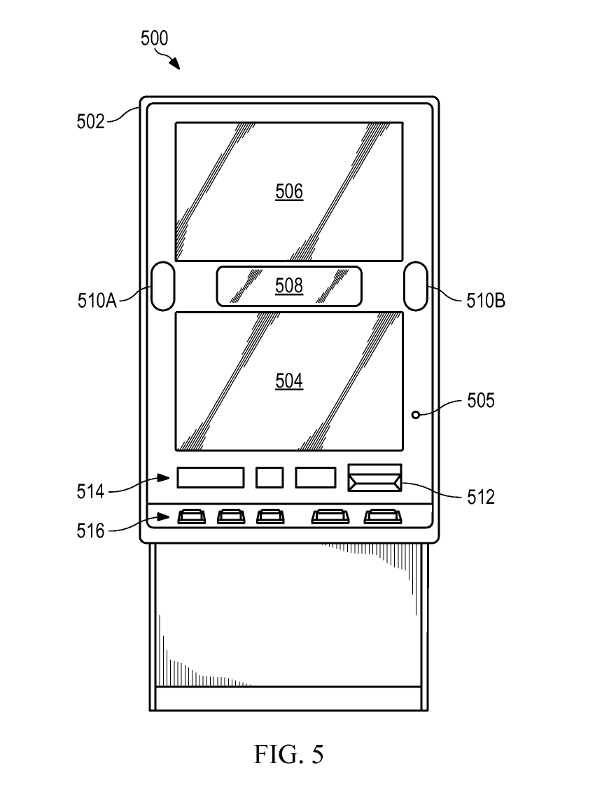

In FIG. 5, a diagram of an exemplary gaming device 500 is shown, according to one embodiment. Electronic gaming device 502 may include a first display screen 504, a second display screen 506, a third display screen 508, a first speaker 510A, a second speaker 5108, one or more input/output devices 514, one or more input devices 516, a voucher device 512, and/or one or more visual devices 505. One or more visual devices 505 (e.g., camera, etc.) may be utilized to transmit and/or receive data from (and/or to) electronic gaming device 502 to (and/or from) one or more mobile devices.

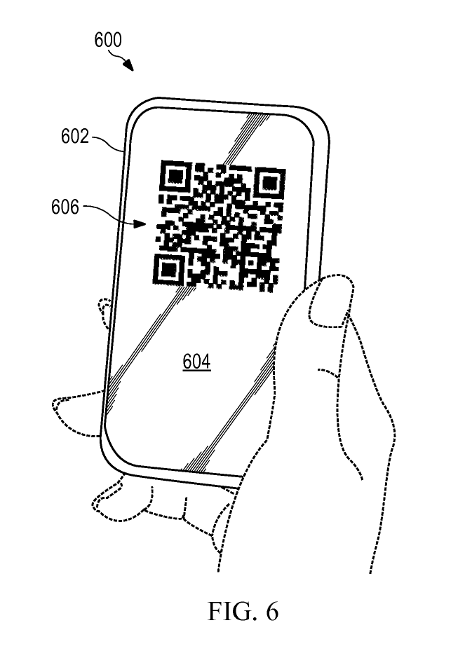

In FIG. 6, a diagram of an exemplary mobile device 600 is shown, according to one embodiment. In one example, mobile device 602 may include a screen 604 with one or more codes 606 (e.g., QR code, bar code, etc.). In one example, one or more codes 606 may be transmitted to electronic gaming device 502 to initiate the player's universal player tracking card via one or more visual devices 505. This initiation may be verification via one or more security procedures. Further, the initiation and/or verification may be based on one or more data signals in combination with the above and/or as a standalone option.

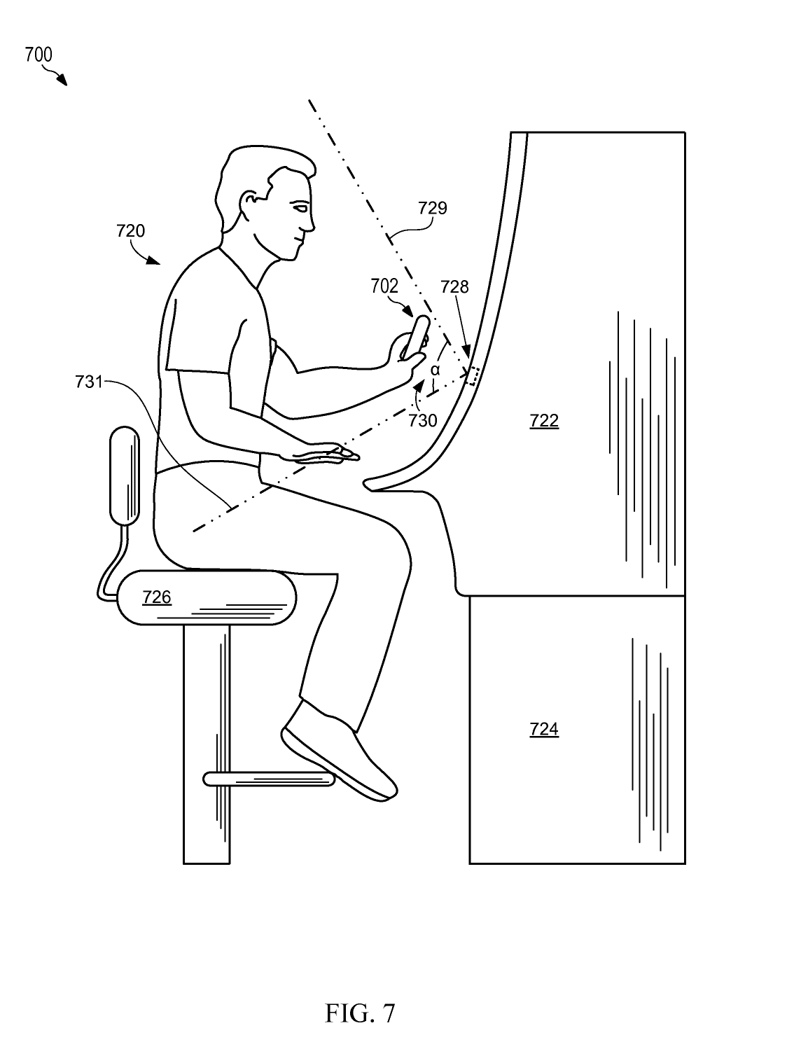

In FIG. 7, a diagram of an exemplary gaming device 700 is shown, according to one embodiment. In this example, mobile device 702 is positioned by player 720 to be within the optical range (e.g., perceived range, etc.) of the one or more visual devices 728 (e.g., cameras, sensors, etc.). The optical range may include a first range line 729, a second range line 731, and a range angle 730.

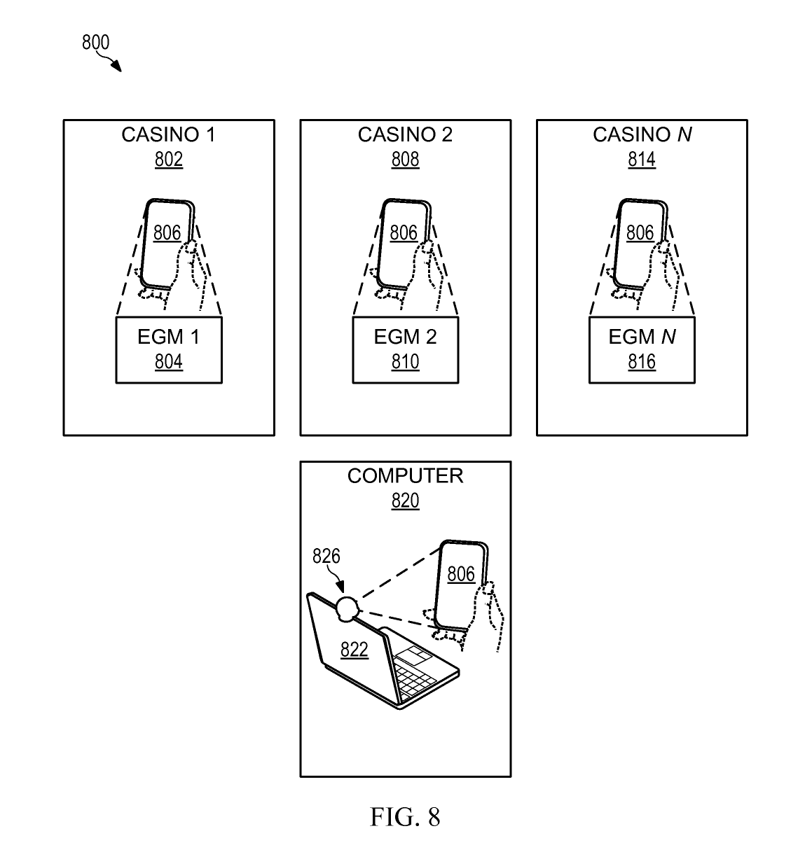

In FIG. 8, an illustration of an exemplary universal player tracking program 800 is shown, according to one embodiment. In various examples, a player via a mobile device may transmit a QR code 806 to initiate their universal player's card account on a first gaming device 804 at a first casino 802, a second gaming device 810 at a second casino 808, an Nth gaming device 816 at an Nth casino, and/or a remote gaming device 822 (and/or remote gaming site via camera 826). In these various examples, the universal player tracking system utilizes the QR codes and/or any other information (e.g., player picture, finger print, etc.) to verify the authentication of the universal player tracking number and the identity of the player.

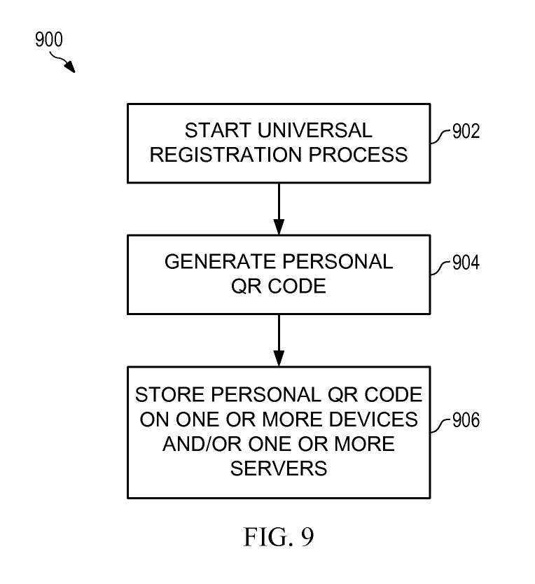

In FIG. 9, a flow diagram for the universal registration procedure 900 is shown, according to one embodiment. The universal registration procedure 900 may include starting the universal registration process (step 902). The method may include generating a personal QR code (step 904). The method may include storing the personal QR code on one or more devices and/or one or more servers (step 906). In one example, the QR code may be replaced and/or supplemented by bar codes, other codes, signals, and/or any other validation data (e.g., finger print, photo, etc.). In another example, a first player may register for the universal player card tracking system via a gaming terminal, a gaming machine, an online site, a casino terminal, a casino host site, and/or any other computing device. In addition, the first player may be required to enter personal data (e.g., birth date, name, address, etc.) to obtain the universal player tracking card. In addition, an anchor site (e.g., host casino, casino where the player signed up, etc.) may be tagged to the player's universal card number. The anchor site may be utilized as the location where promotions are sent out from, where account balance statements are sent from, and/or for any other purpose. In one example, an anchor site may be selected by the player. In another example, an anchor site may be related to where the player's home address is. Further, an anchor site may be based on where the player gambles the most.

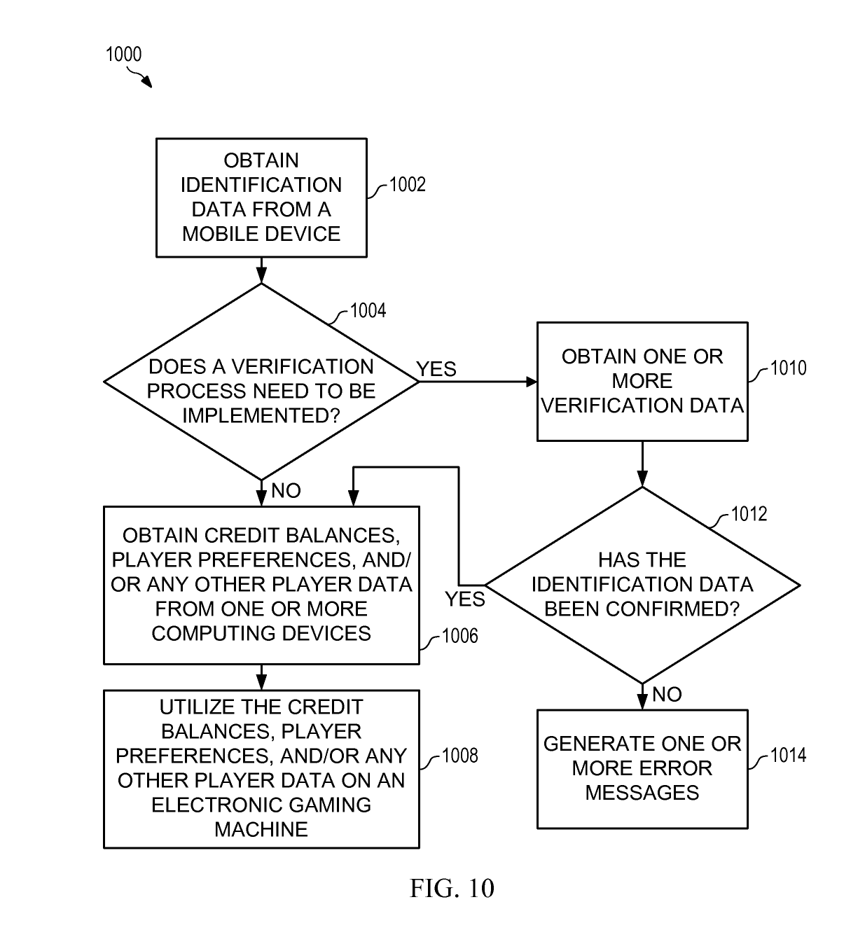

In FIG. 10, a flow diagram for verification procedure 1000 is shown, according to one embodiment. The method may include obtaining identification data from a mobile device (and/or any other computing device) (step 1002). The method may include one or more processors (e.g., electronic gaming device 100 and/or electronic gaming system 200) determining whether a verification process needs to be implemented (step 1004). If a verification process needs to be implemented, then the method may include obtaining one or more verification data (step 1010). The method may then via one or more processors determine whether the identification data has been confirmed (step 1012). If the identification data has not been confirmed, then the method may generate one or more error messages (step 1014). If the identification data has been confirmed and/or no verification process was needed, then the method may include obtaining credit balances, player preferences, and/or any other player data from one or more computing devices (e.g., servers, computer, gaming devices, etc.) (step 1006). The method may include utilizing the credit balances, player preferences, and/or any other player data on the electronic gaming machine (step 1008).

In one example, a first player's information may not need to be validated based on the player frequency of game play on the electronic gaming device and/or at the gaming entity. In another example, no validation may be required based on the game mode (e.g., tournament mode, base mode, bonus mode, etc.). In another example, no validation procedure may be utilized at all.

In another example, a validation procedure may be utilized, such as, a photo validation via the electronic gaming device. In another example, biometric data (e.g., finger print, eye scan, etc.) may be utilized to validate the universal player tracking card.

In another example, if the validation procedure fails, then a message may be sent to the player, to security, to the host, and/or any other party. Further, a credit balance for game play may be sent to the electronic gaming device to allow the player to initiate game play on the electronic gaming device. For example, a player may have a dollar balance of $100 and a player's point balance of 10,000 points. In one example, the $100 dollar balance may be transferred into electronic gaming device for game play. In another example, the electronic gaming device may ask whether the player would like to convert any and/or all of the 10,000 player's point balance into playable credits. In one example, a player may receive a penny for every player point. Therefore, in the above-referenced example, the player could convert the 10,000 player point into another $100 of game play.

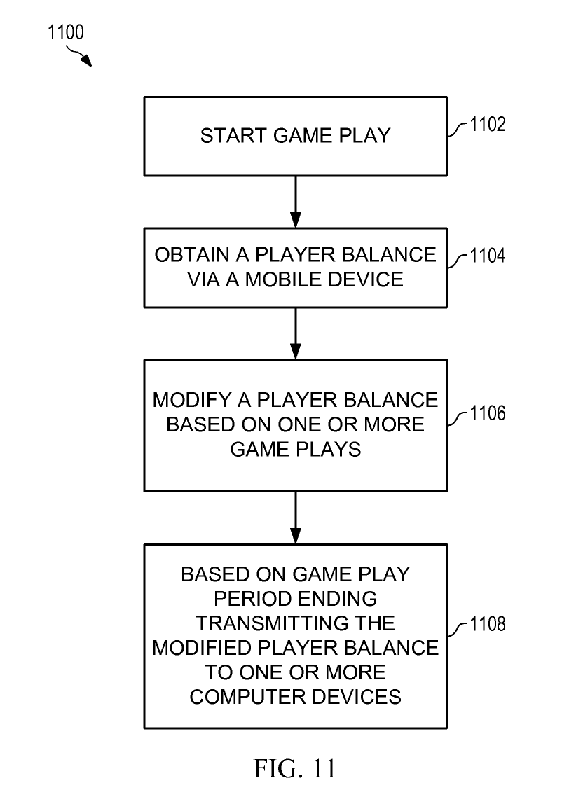

In FIG. 11, a flow diagram for modifying a player's balance 1100 is shown, according to one embodiment. The method may include starting game play (step 1102). The method may include obtaining a player balance via a mobile device (and/or any other computing device) (step 1104). The method may include modifying a player balance based on one or more game plays (step 1106). The method may include transmitting the modified player balance to one or more computing devices based on the game play period ending (step 1108). For example, a player may have a player's point balance of 50,000 points before game play starts on a first gaming device. During game play on the first gaming device, the player may have generated another 500 player points. Therefore, at the end of game play on the first gaming device, a computing device (e.g., server, gaming device, etc.) may modify the player's point balance from 50,000 to 50,500. The player may then move to a second gaming device with the 50,500 point balance. During game play on the second gaming device, the player may have generated another 1,500 player points but utilized 500 player points to receive a dinner coupon (which was transferred to their mobile device). Therefore, at the end of game play on the second gaming device, the computing device may modify the player's point balance from 50,500 to 51,500 (e.g., 50,500+1,500−500=51,500). In one example, the player points may be earned at different rates on different machines (e.g., for the same bet a first gaming machine awards 100 points, a second gaming machine awards 110 points, etc.).

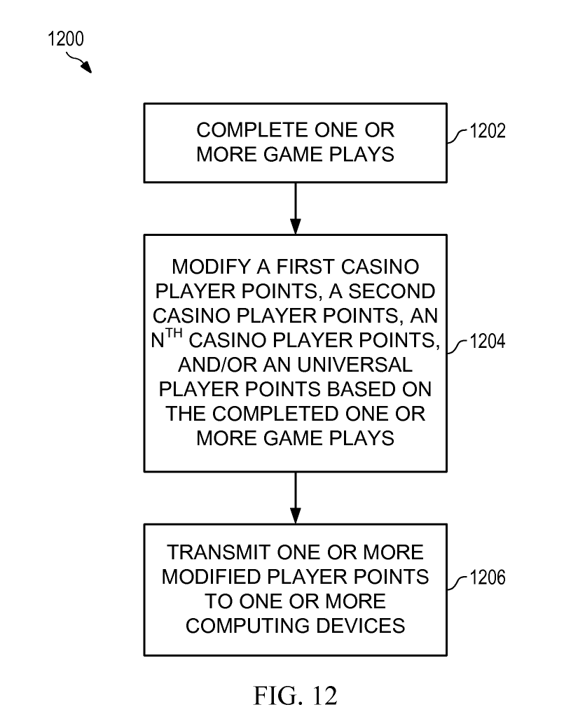

In FIG. 12, another flow diagram for modifying a player's balance 1200 is shown, according to one embodiment. The method may include completing one or more game plays (step 1202). The method may include modifying a first casino player points, a second casino player points, an Nth casino player points, and/or an universal player points based on the completed one or more game plays (step 1204). The method may include transmitting one or more modified player points to one or more computing devices (step 1206).

In one example, a player may be playing an electronic gaming device at a first casino that has both a casino specific player's card and the universal player's card. The electronic gaming device may include both universal player card supported game types and non-universal player card supported game types (e.g., game types that do not support the utilization of the universal player card system). During a game play session, the player plays both the universal player card supported game types and non-universal player card supported game types. In this example, the player generates 1,000 points on the universal type games and 500 points on the non-universal type games. Therefore, at the end of game play the universal player card's balance would be increased by 1,000 points. Whereas, at the end of game play the non-universal player card's balance would be increased by 500 points. In another example, both universal player points and non-universal player points may be earned at the same time. For example, on a first gaming device a player may earn 100 non-universal player points and 50 universal player points for betting $5 on a machine for 1 hour.

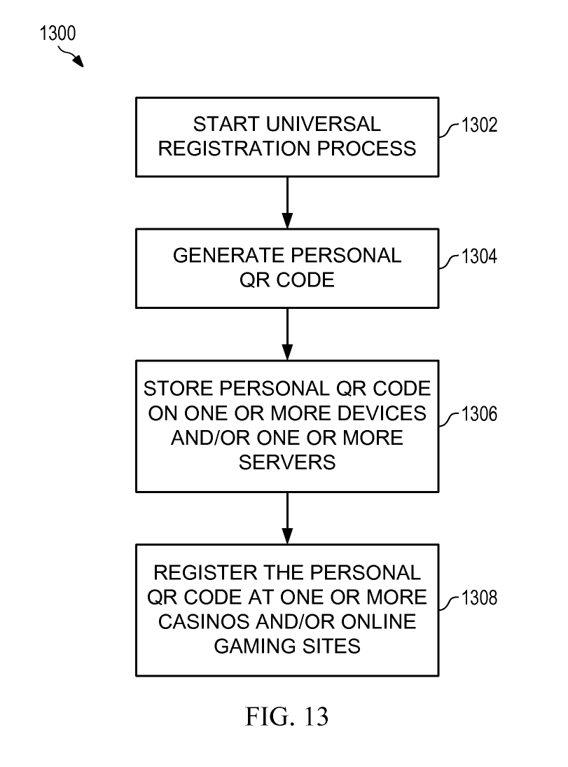

In FIG. 13, a flow diagram for storing player information 1300 is shown, according to one embodiment. The method may include starting the universal registration process (step 1302). The method may include generating a personal QR code (step 1304). The method may include storing the personal QR code on one or more computing devices and/or one or more servers (step 1306). The method may include registering the personal QR code at one or more casinos and/or online gaming sites (step 1308).

For example, once the player has registered for one or more universal player tracking systems, this information may be transmitted to one or more gaming entity to register this player's universal player tracking data (e.g., card number, player preferences, etc.).

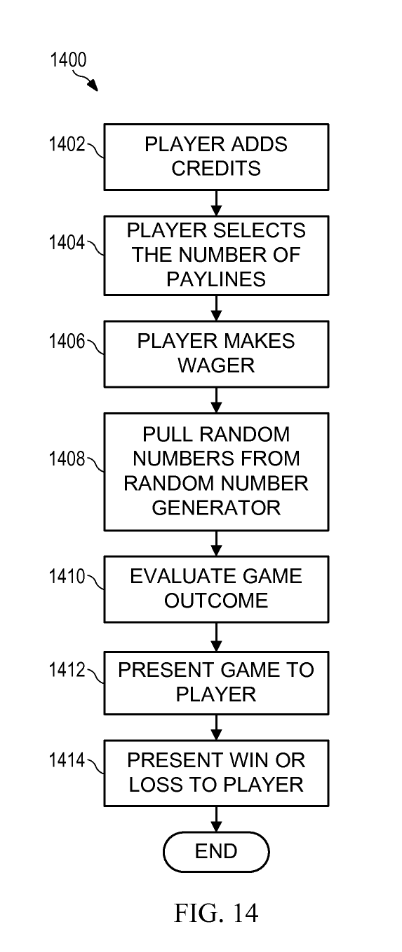

FIG. 14 is a process flowchart of one example of a primary game play 1400 on an electronic gaming system, according to one embodiment. The method may include the step of a player adding credit to the electronic gaming system (step 1402). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1404, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1406, the player makes a wager on the game. In one embodiment, the wager may be a multiple of the number of paylines selected at step 1404. In another embodiment, the wager may not be a multiple of the number of paylines selected at step 1404. In a further embodiment, the wager may include a side-wager (e.g., ante bet), which may, in one example of such an embodiment, be used to make the player eligible to be awarded the extra functionality discussed above. It should be appreciated that in some embodiments, the order of steps 1404 and 1406 may be not critical, and so for example, a player can select the wager they wish to place, and then select the number of paylines they want it applied to, and that these embodiments are expressly contemplated as being within the scope of the present disclosure.

Continuing to step 1408, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 1410 and 1412, the gaming system utilizes the random numbers pulled at step 1408 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1414, the win or loss outcome may be identified for the player. In one embodiment, this step can include additional messaging, which provides information related to the win or loss, such as why the player won or lost. In another embodiment, this step can include identification of the amount of any award earned by the player.

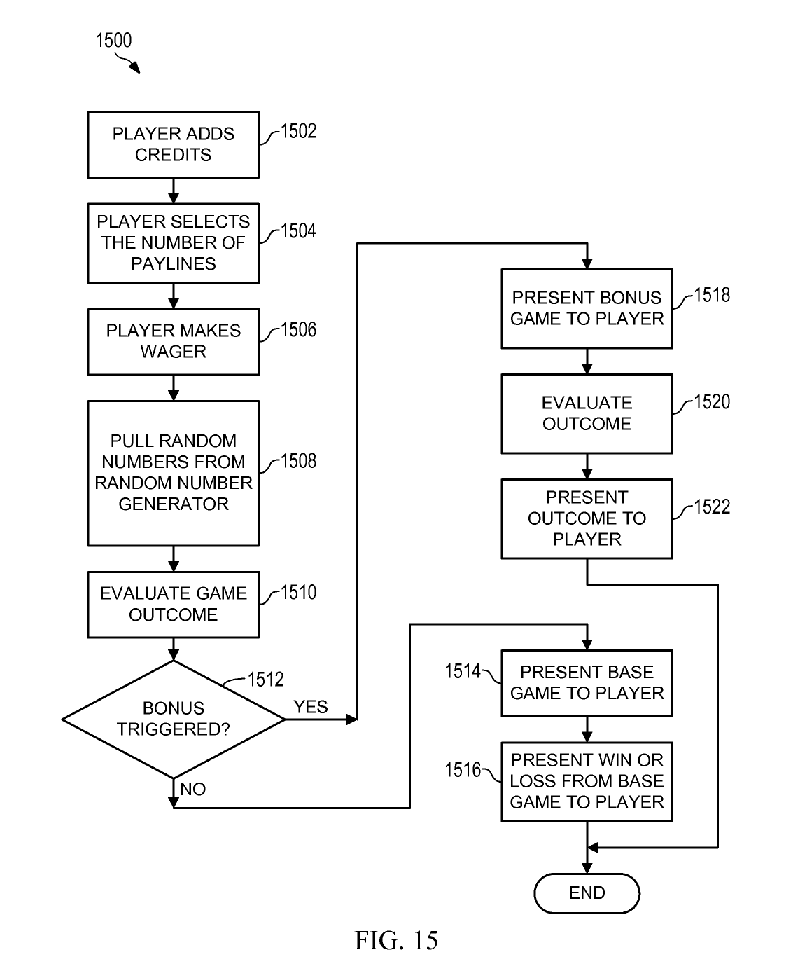

FIG. 15 is a process flowchart of one example of a combined primary and secondary game play 1500 on an electronic gaming system, according to one embodiment. The method may include the step of a player adding credit to the electronic gaming system (step 1502). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1504, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1506, the player makes a wager on the game. In one embodiment, the wager may be a multiple of the number of paylines selected at step 1504. In another embodiment, the wager may not be a multiple of the number of paylines selected at step 1504. In a further embodiment, the wager may include a side-wager, which may, in one example of such an embodiment, be used to make the player eligible to be awarded the extra functionality discussed above. It should be appreciated that in some embodiments, the order of steps 1504 and 1506 may be not critical, and so for example, a player can select the wager they wish to place, and then select the number of paylines they want it applied to, and that these embodiments may be expressly contemplated as being within the scope of the present disclosure.

Continuing to step 1508, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 1510, the gaming system utilizes the random numbers pulled at step 1508 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1512, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 1514, where the base game may be fully presented to the player. As discussed above, the orders of step 1510, 1512, and 1514 can be changed without affecting the novel concepts disclosed herein.

At step 1516, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 1512 that a bonus or secondary game was triggered, then process 1500 continues to step 1518, where the secondary game may be presented to the player. As discussed above, there are numerous ways to present the secondary or bonus game to the player.

At steps 1520 and 1522, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 1500 ending after step 1522, the process continues to step 1514 so as to finalize the primary game outcome presentation to the player.

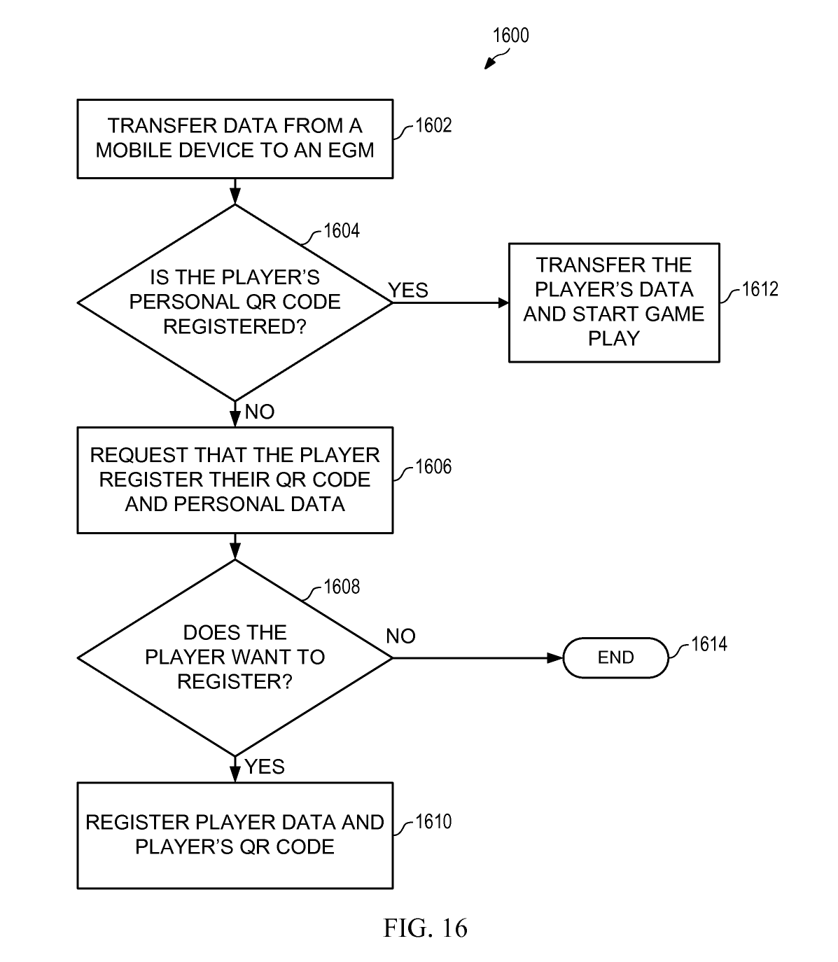

In FIG. 16, another flow diagram for a registration procedure 1600 is shown, according to one embodiment. The method may include transferring data from a mobile device (and/or any other computing device) to electronic gaming device 100 and/or electronic gaming system 200 (step 1602). The method may include one or more processors determining whether the player's personal QR code is registered (step 1604). If the player's personal QR code is registered, then the method may include transferring the player's data and starting one or more game plays (step 1612). If the player's personal QR code is not registered, then the method may include requesting that the player register their QR code and/or personal data (step 1606). The method may include one or more processors determining whether the player wants to register their QR code and/or personal data (step 1608). If the player does not want to register their QR code and/or personal data, then the method may end (step 1614). If the player wants to register their QR code and/or personal data, then the method may include registering the player's data and/or the player's QR code (step 1610).

In one embodiment, the electronic gaming device may include a memory, one or more processors, and a plurality of reels. The plurality of reels may include one or more areas. The memory may include an universal player tracking module. The processor may generate one or more symbols to be located in the one or more areas. Further, the processor may validate one or more universal player tracking numbers based on data received from an external device.

In another example, the universal player tracking number may be utilized at one or more gaming entities. In one example, the one or more gaming entities include a first gaming entity and a second gaming entity where the first gaming entity and the second gaming entity are distinct and non-related entities. In one example, a distinct and non-related entity means two different locations and not owned by the same entity. In an example, the external device is a player's mobile device. In one example, the electronic gaming device includes a non-universal player tracking module. In another example, the non-universal player tracking module may receive a non-universal player tracking number where the non-universal player tracking number is only utilized at related gaming entities. In one example, related gaming entities means that the entities are owned by the same entity. In one example, the processor may validate the one or more universal player tracking numbers via at least one of photo data and biometric data.

In another embodiment, a method of providing game play via an electronic gaming device may include: obtaining via one or more processors an universal player tracking number; transferring player data based on the universal player tracking number; and/or initiating via the one or more processors one or more game plays.

In another example, the method may include validating the universal player tracking number via data received from an external device. In one example, the universal player tracking number is utilized at one or more gaming entities. In one example, the one or more gaming entities include a first gaming entity and a second gaming entity where the first gaming entity and the second gaming entity are distinct and non-related entities.

In another embodiment, the electronic gaming system may include a server including a server processor, a server memory, and a display device including a plurality of reels. The plurality of reels including one or more areas. The server memory including one or more universal player tracking numbers. The server processor may validate one or more universal player tracking numbers based on data received from an external device.

In another example, the universal player tracking number is utilized at one or more gaming entities. In one example, the one or more gaming entities include a first gaming entity and a second gaming entity where the first gaming entity and the second gaming entity are distinct and non-related entities. In an example, the external device is a player's mobile device. In another example, the system may include a non-universal player tracking module. Further, the non-universal player tracking module is configured to receive a non-universal player tracking number where the non-universal player tracking number is only utilized at related gaming entities. In addition, the server processor may validate the one or more universal player tracking numbers via at least one of photo data and biometric data.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system may be powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system may be different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

1. An electronic gaming device comprising:
a plurality of reels, the plurality of reels including one or more areas;
a memory, the memory including a universal player tracking module;
a processor configured to generate one or more symbols to be located in the one or more areas, the processor configured to validate one or more universal player tracking numbers based on data received from an external device.

2. The electronic gaming device of claim 1, wherein the universal player tracking number is utilized at one or more gaming entities.

3. The electronic gaming device of claim 2, wherein the one or more gaming entities include a first gaming entity and a second gaming entity where the first gaming entity and the second gaming entity are distinct and non-related entities.

4. The electronic gaming device of claim 1, wherein the external device is a player's mobile device.

5. The electronic gaming device of claim 1, further comprising a non-universal player tracking module.

6. The electronic gaming device of claim 5, wherein the non-universal player tracking module is configured to receive a non-universal player tracking number where the non-universal player tracking number is only utilized at related gaming entities.

7. The electronic gaming device of claim 1, wherein the processor is further configured to validate the one or more universal player tracking numbers via at least one of photo data and biometric data.

8. A method of providing game play via an electronic gaming device comprising:
obtaining via one or more processors a universal player tracking number;
transferring player data based on the universal player tracking number; and
initiating via the one or more processors one or more game plays.

9. The method of claim 8, further comprising validating the universal player tracking number via data received from an external device.

10. The method of claim 8, wherein the universal player tracking number is utilized at one or more gaming entities.

11. The electronic gaming device of claim 10, wherein the one or more gaming entities include a first gaming entity and a second gaming entity where the first gaming entity and the second gaming entity are distinct and non-related entities.

12. An electronic gaming system comprising:
a server including a server processor and a server memory;
a display device including a plurality of reels, the plurality of reels including one or more areas;
the server memory including one or more universal player tracking numbers;
the server processor configured to validate one or more universal player tracking numbers based on data received from an external device.

13. The electronic gaming system of claim 12, wherein the universal player tracking number is utilized at one or more gaming entities.

14. The electronic gaming system of claim 13, wherein the one or more gaming entities include a first gaming entity and a second gaming entity where the first gaming entity and the second gaming entity are distinct and non-related entities.

15. The electronic gaming system of claim 12, wherein the external device is a player's mobile device.

16. The electronic gaming system of claim 1, further comprising a non-universal player tracking module.

17. The electronic gaming system of claim 16, wherein the non-universal player tracking module is configured to receive a non-universal player tracking number where the non-universal player tracking number is only utilized at related gaming entities.

18. The electronic gaming system of claim 12, wherein the server processor is further configured to validate the one or more universal player tracking numbers via at least one of photo data and biometric data.
